(19) United States
(12) Patent Application Publication
(10) Pub. No.: US 2018/0025348 A1
(43) Pub. Date: Jan. 25, 2018

(54) METHOD SYSTEM OF ONLINE PAYMENT USING MOBILE DEVICE AND CONTACTLESS EMV CARD

(71) Applicants: Jack Shauh, San Diego, CA (US); Andrew Vinh Banh, Irvine, CA (US)

(72) Inventors: Jack Shauh, San Diego, CA (US); Andrew Vinh Banh, Irvine, CA (US)

(21) Appl. No.: 15/657,119

(22) Filed: Jul. 22, 2017

Related U.S. Application Data
(60) Provisional application No. 62/365,983, filed on Jul. 23, 2016.

(51) Int. Cl. G06Q 20/34; G06Q 20/40; G06Q 20/38

(52) U.S. Cl. CPC G06Q 20/352; G06Q 20/382; G06Q 20/4018

(57) ABSTRACT

An online payment system and method including a mobile device with an NFC reader capability is disclosed. An online merchant is coupled in communication between a payment network and the mobile device. A contactless EMV IC card containing card information is provided for making a payment. The card information is readable from the contactless EMV IC card by the NFC reader of the mobile device and sent to the payment network.

### CROSS-REFERENCE TO RELATED APPLICATION

This application claims the benefit of U.S. Provisional Application No. 62/365,983, filed 23 Jul. 2016.

### FIELD OF THE INVENTION

This invention relates to mobile device payment systems.

More particularly, the present invention relates to mobile device payment for online purchases employing contactless EMV cards.

### BACKGROUND OF THE INVENTION

Mobile devices have become very popular as an eCommerce platform. The user uses a mobile device to connect to the online merchant. When the user decides to make a payment, in the existing payment method, the user needs to manually enter the credit or debit card information, e.g. card number, cardholder name, expiration date, digits of CVV (Card Verification Value), billing address information, etc. When the online merchant receives the credit or debit card information, it sends an authorization request with credit or debit card information and authorized amount, etc., to a payment network to approve the transaction.

Currently, credit or debit card technology is migrating from a magnetic stripe card to an IC card. EMV (Europay, MasterCard and Visa) has created EMV Integrated Circuit Card Specifications in which an IC card provides computation to verify the card and cardholder. An EMV IC card can be contact or contactless. In a contact EMV IC card, the card needs to be inserted into the slot of a POS (Point of Sale) terminal in order to process the transaction. In a contactless EMV IC card, the card needs to be near the POS terminal and NFC (Near Field Communication) provides a communication link in order to exchange messages.

The problem with the current payment method for ecommerce using a mobile device, is that the current procedure of manually typing credit or debit card information is very inconvenient. Besides, EMV in POS procedures are too complex to work in the scenarios of online shopping. Therefore, a solution acceptable to both the user and the online merchant is needed.

It would be highly advantageous, therefore, to remedy the foregoing and other deficiencies inherent in the prior art.

An object of the present invention is to provide a method and system for online purchases using mobile devices and contactless EMC cards.

### SUMMARY OF THE INVENTION

Briefly, to achieve the desired objects and advantages of the instant invention, provided is an online payment system including a mobile device with an NFC reader capability. An online merchant is coupled in communication between a payment network and the mobile device. A contactless EMV IC card containing card information is provided for making a payment. The card information is readable from the contactless EMV IC card by the NFC reader and sent to the payment network.

Also provided is an online payment method using a mobile device and contactless EMV IC card. The method includes the steps of providing a mobile device including an NFC reader capability. Coupling the mobile device in communication with an online merchant. The mobile device receives purchase information from the online merchant. A contactless EMV IC card containing card information for making a payment is provided. A payment transaction is made with the contactless EMV IC card by positioning the contactless EMV IC card proximate the mobile device with NFC reader capability and reading card information from the contactless EMV IC card. The contactless EMV IC card is authenticated and card information is transferred to the online merchant. An authorization request is sent from the online merchant to a payment network, and an authorization response is sent from the payment network to the online merchant. The authorization response can be an approval or a rejection.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified schematic diagram of the mobile device online payment system according to the present invention;

FIG. 2 is a schematic of the message flow within the mobile device online payment system of the present invention;

FIG. 3 is a schematic of another example of message flow within the mobile device online payment system of the present invention;

FIG. 4 is a schematic of yet another example of message flow within the mobile device online payment system of the present invention;

FIG. 5 is a schematic of a further example of message flow within the mobile device online payment system of the present invention;

FIG. 6 is a schematic of an example of message flow within the mobile device online payment system of the present invention which includes a PC; and

FIG. 7 is a schematic of an example of message flow within the mobile device online payment system of the present invention which includes a PC and a server.

### DETAILED DESCRIPTION OF THE PREFERRED EMBODIMENTS

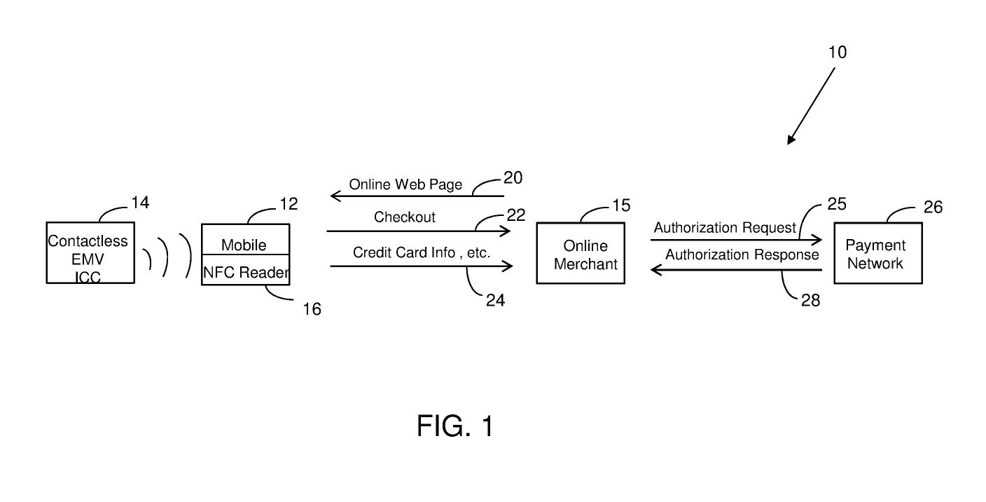

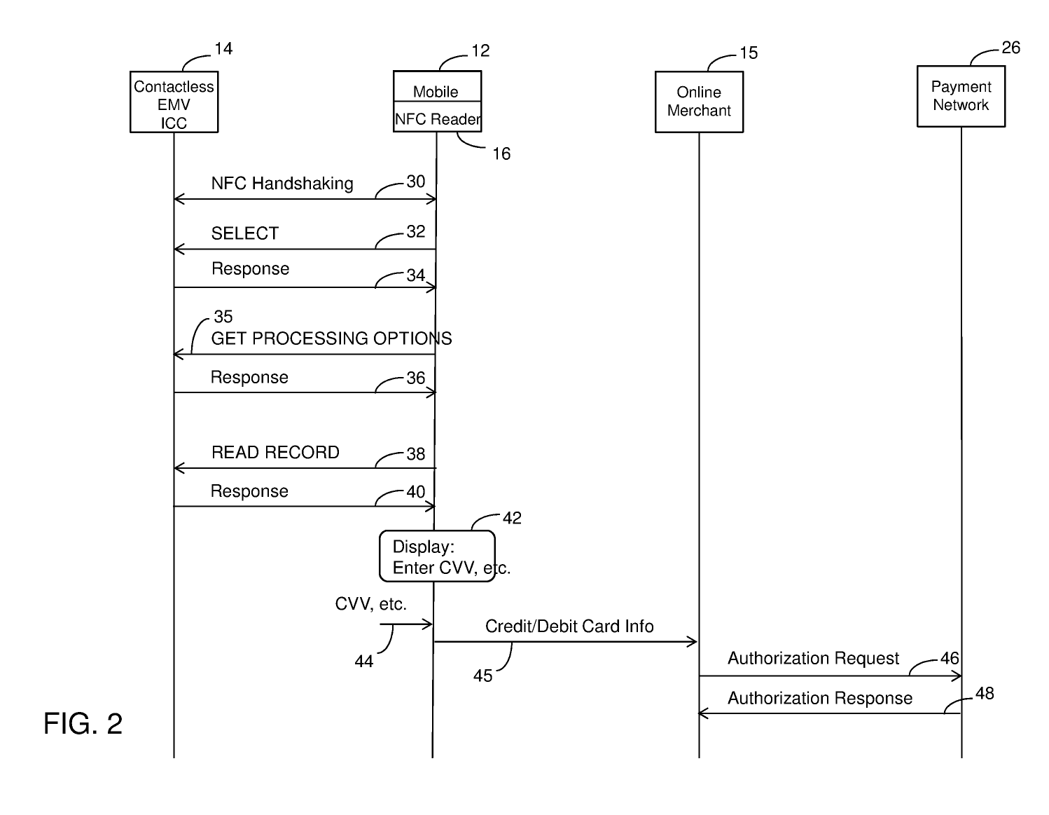

Turning now to the drawings in which like reference characters indicate corresponding elements throughout the several views, attention is first directed to FIG. 1 which illustrates a simplified block diagram of an online mobile device payment system generally designated 10. System 10 includes a mobile device 12 with NFC capability for interaction with a contactless EMV IC card 14. Mobile device 12 is a smart phone, tablet device, wearable device, or the like, that can support NFC capability and is internet browsing capable. An NFC reader 16 is provided by using an application to enable the NFC capability of mobile device 12. To make a payment for a purchase at an online merchant 15, purchase information is received by mobile device 12 from online merchant 15. A user moves contactless EMV IC card 14 close to mobile device 12 having NFC reader 16 enabled therein. NFC reader 16 reads the information from EMV IC card 14 to process the transaction. To avoid impact on online merchant 15, an existing interface of online merchant 15 or minimal modification of the online communication is used between mobile device 12 and online merchant 15. To achieve online communication, mobile device 12 downloads an application to run the procedure. Alternatively, a generic browser in mobile device 12 can be allowed to run the procedure with downloading a script. Mobile device 12 couples to online merchant 15 through a network such as the internet. A user employs mobile device 12 to access an online web page 20 of online merchant 15 and selects products or services to purchase and then performs a checkout 22 and received purchase information such as cost, product identification and the like. Payment for the purchase is supplied by contactless EMV card 14 being positioned proximate NFC reader 16 of mobile device 12 by the user. Payment information 24, e.g. credit card information, is read from card 14 by NFC reader 16 and provided by mobile device 12 to online merchant 15 which then forwards an authorization request 25 to a payment network 26. Payment network 26 then passes an authorization response 28 to online merchant 15. Payment network 26 can include a payment gateway, an acquiring bank, a brand network, an issuing bank, etc. Referring now to FIG. 2, an example of the steps of the payment method of the present invention are described. In this method, online merchant 15 will only rely on the credit or debit card information, e.g. card number, cardholder name, expiration date, 3 or 4 digits of CVV (Card Verification Value), billing address information, etc. to authenticate and process the transaction. The data for this process are read from EMV IC card 14. When the user wants to purchase and make payment, after receiving a payment request from online merchant 15 including purchase information, the user positions contactless EMV IC card 14 close to mobile device 12 having NFC reader 16 capability. The mobile application connects to online merchant 15, detects the presence of contactless EMV IC card 14 and performs a handshaking procedure 30 as needed. Mobile device 12 with NFC reader 16 sends EMV SELECT message 32 to EMV ICC card 14 in order to determine and select the application in EMV ICC card 14 which provides the credit or debit card payment, and receives response 34. Mobile device 12 with NFC reader 16 sends EMV “GET PROCESSING OPTIONS” message 35 to EMV ICC card 14. EMV ICC card 14 responds 36 with an Application Interchange Profile and an Application File Locator (AFL), etc. An Application Interchange Profile indicates the capability of EMV ICC card 14, such as SDA (Static Data Authentication), DDA (Dynamic Data Authentication), cardholder verification to be performed, and the like. The AFL identifies the files and records containing the data to be used for the transaction. Mobile device 12 with NFC reader 16 sends EMV READ RECORD message 38 to EMV ICC card 14 in order to read data needed for the transaction. EMV ICC card 14 replies 40 with data including Application Effective/Expiration Dates, Application Primary Account Number (PAN), Cardholder Name, Track 2 Equivalent Data, Signed Static Application Data (SSAD), Issuer Public Key, ICC Public Key, and the like. Track 2 Equivalent Data contains Primary Account Number, Expiration Date, Cardholder Name, etc., which may be duplicated from other parameters in the response. From response 40, mobile device 12 extracts the key information such as Primary Account Number, Cardholder Name, Expiration Date, to be provided to online merchant 15. After receiving the information from EMV ICC card 14, mobile device 12 displays a message 42 indicating any missing information required to be input by the user, and indicates the user can now remove card 14. The user then inputs 44 the missing information. For example, the missing information may include a CVV code consisting of 3 or 4 digits shown on the front or rear of EMV ICC card 14. Additional information, such as billing address, phone number, and email address may need to be entered by the user, indicated by message 42. However, additional information may already be stored in the mobile application or cached in mobile device 12 from browser context. Therefore, the user does not need to re-enter information and this step may be skipped. Mobile device 12 sends all credit or debit card information 45 to online merchant 15. Online merchant 15 sends an authorization request 46 to payment network 26 to request transaction approval. Payment network 26 replies with an authorization response 48 and the transaction is approved or rejected.

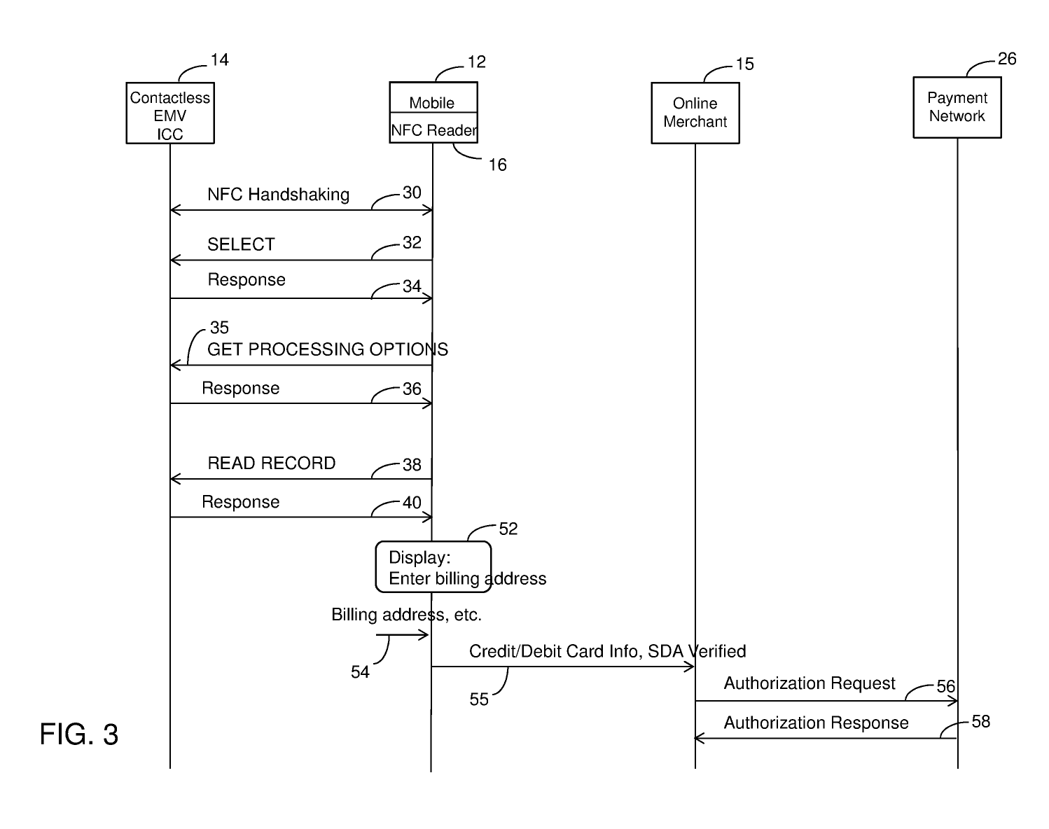

To avoid the necessity of a user being required to enter a CVV, mobile device 12 can verify Signed Static Application Data (SSAD) using the Issuer Public Key that was received from EMV ICC card 14. If verification succeeds, then the process continues, if verification fails, the process is terminated. Referring to FIG. 3, this example of the steps of the payment method of the present invention is described. The initial steps are the same as those described in the previous example, up to EMV ICC card 14 replying 40 with data. In addition, mobile device 12 runs SDA to verify Signed Static Application Data (SSAD) using the Issuer Public Key that was received from EMV ICC card 14 in reply 40. If verification succeeds, the process continues, and if verification fails, the process is terminated. After receiving the information, mobile device 12 displays a message 52 with a requirement to enter any missing information 54. For example, the missing information may include billing address, phone number, email address and the like. The information may already be stored in the mobile App or cached in the mobile device of browser context. In this case, the user does not need to re-enter information and this step may be skipped. Mobile device 12 sends all credit or debit card information and SDA Verified status 55 to online merchant 15. Online merchant 15 sends authorization request 56 to the payment network 26 to request transaction approval. Payment network 26 replies with an authorization response 58 and the transaction is approved or rejected.

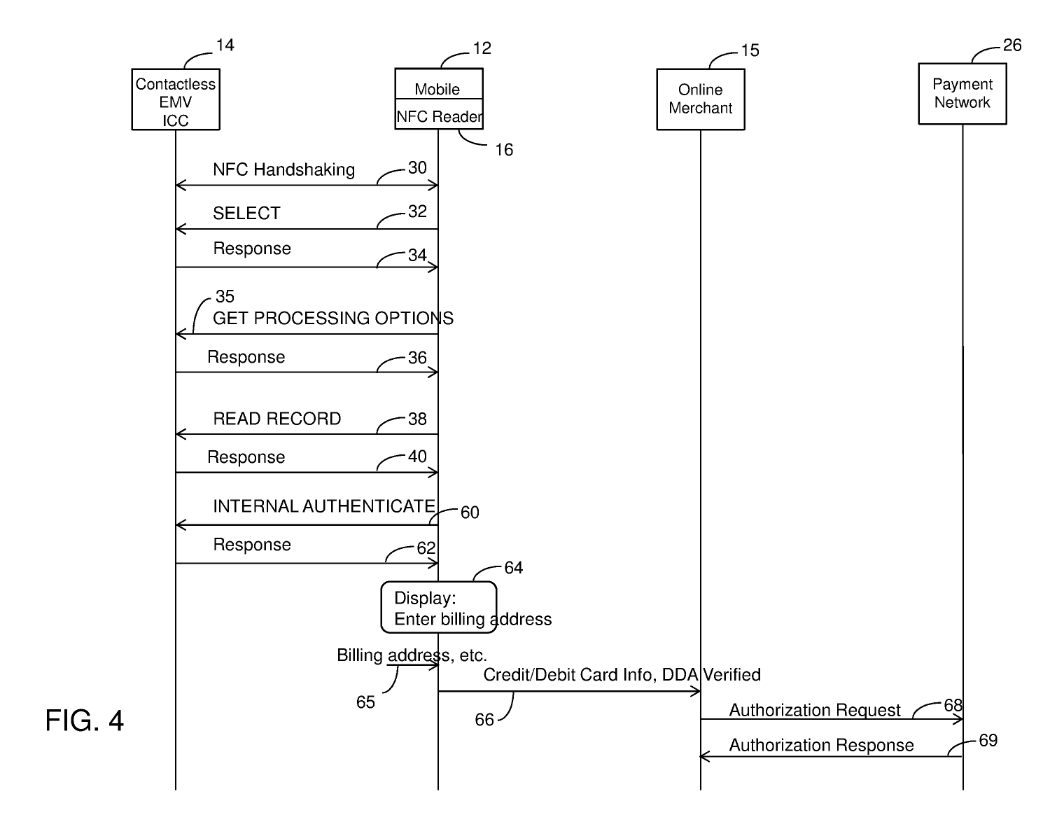

Another variation of the method of the present invention is illustrated in FIG. 4. In this example of the method, a user is not required to enter CVV. Instead, mobile device 12 verifies Signed Dynamic Application Data (SDAD) using the ICC Public Key that was received from EMV ICC card 14 in reply 40. If verification succeeds, then the process continues, if verification fails, the process is terminated. In this example the initial steps are again the same as those described in the previous examples, up to EMV ICC card 14 replying 40 with data. At this point, mobile device 12 with NFC Reader 16 sends EMV INTERNAL AUTHENTICATE message 60 to EMV ICC card 14 in order to run DDA. INTERNAL AUTHENTICATE message 60 includes a random number (i.e. unpredictable number) generated by mobile device 12. EMV ICC card 14 responds with Signed Dynamic Application Data (SDAD) 62. SSAD 62 is verified by mobile device 12 using ICC Public Key for Dynamic Data Authentication (DDA). After receiving the information, mobile device 12 displays a message 64 with a requirement to enter any missing information 65. For example, the missing information may include billing address, phone number, email address and the like. The information may already be stored in the mobile App or cached in the mobile device of browser context. In this case, the user does not need to re-enter information and this step may be skipped. Mobile device 12 sends all credit or debit card information and DDA Verified status 66 to online merchant 15. Online merchant 15 sends authorization request 68 to the payment network 26 to request transaction approval. Payment network 26 replies with an authorization response 69 and the transaction is approved or rejected.

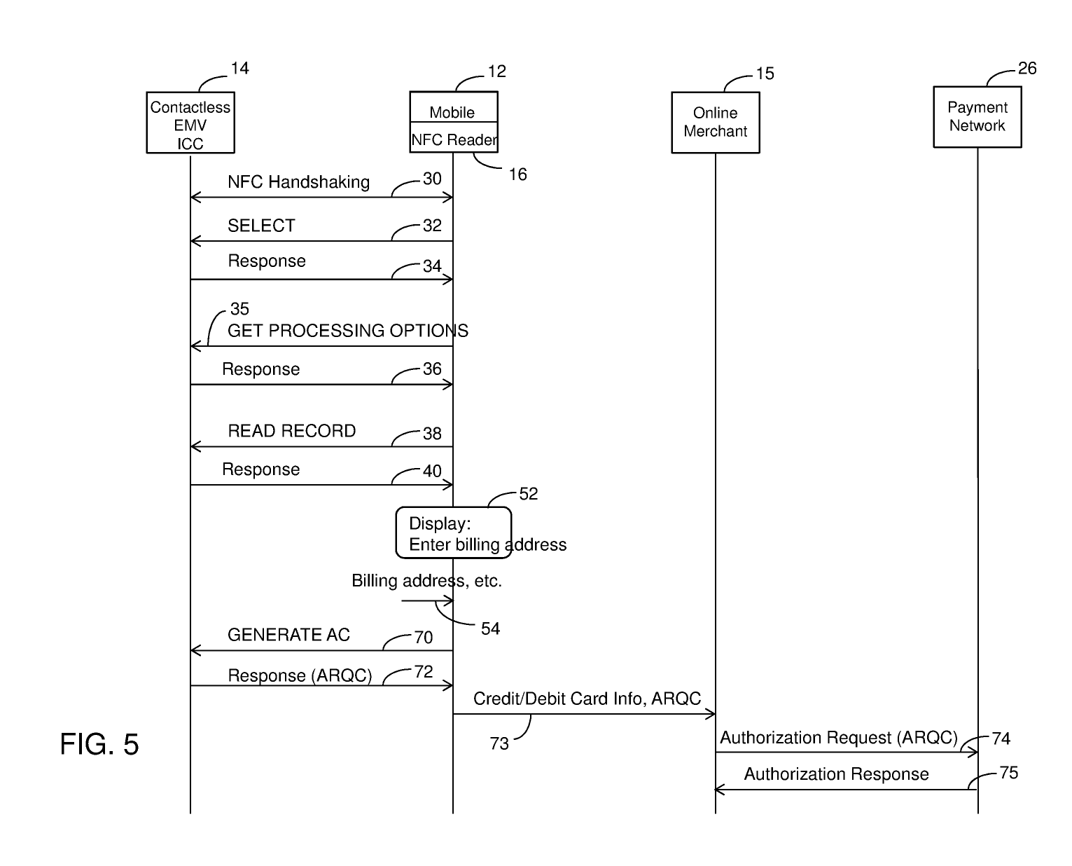

In the previous examples illustrated in FIGS. 3 and 4, the credit or debit chip card 14 is verified by offline authentication with SDA or DDA. With reference to FIG. 5, an example is illustrated wherein online authentication of card 14 can be used. This method may require more processing by online merchant 15 to receive ARQC from card 14 and send to payment network 26 for authentication of card 15. In this example the initial steps are again the same as those described in the previous examples, up to EMV ICC card 14 replying 40 with data. After receiving the information, mobile device 12 displays a message 52 with a requirement to enter any missing information 54. For example, the missing information may include billing address, phone number, email address and the like. The information may already be stored in the mobile App or cached in the mobile device of browser context. In this case, the user does not need to re-enter information and this step may be skipped. Mobile device 12 with NFC reader 16 sends EMV GENERATE AC message 70 to EMV ICC card 14 to request online verification. GENERATE AC message 70 includes transaction specific data (e.g. transaction amount, transaction currency code, transaction date), unpredictable number, etc. which comes from online merchant 15 during the checkout and payment stage. EMV ICC card 14 responds 72 with ARQC (Authorization Request Cryptogram). ARQC is a cryptogram generated by EMV ICC card 14 using a random number (i.e. unpredictable number), transaction specific data and ICC private key. Mobile device 12 sends all credit or debit card information and ARQC 73 to online merchant 15. Online merchant 15 sends authorization request 74 to payment network 26 to request for transaction approval and authenticate card 14. Payment network 26 replies with an authorization response 75 and the transaction is approved or rejected.

In FIGS. 2-5, mobile device 12 can connect to different online merchants 15 instead of the same merchant each time. Merchant specific information is needed to run the procedures. In the initial process before handshake 30, merchant 15 sends a message to mobile device 12 (not shown in the FIGS.), which includes merchant specific information to run merchant specific procedures in subsequent steps. This merchant specific information includes Supported Payment Brands List, etc. Supported Payment Brands List (e.g. Master, Visa, American Express, etc.) can be used by mobile device 12 to select the application or detect if the user uses the supported card by the merchant.

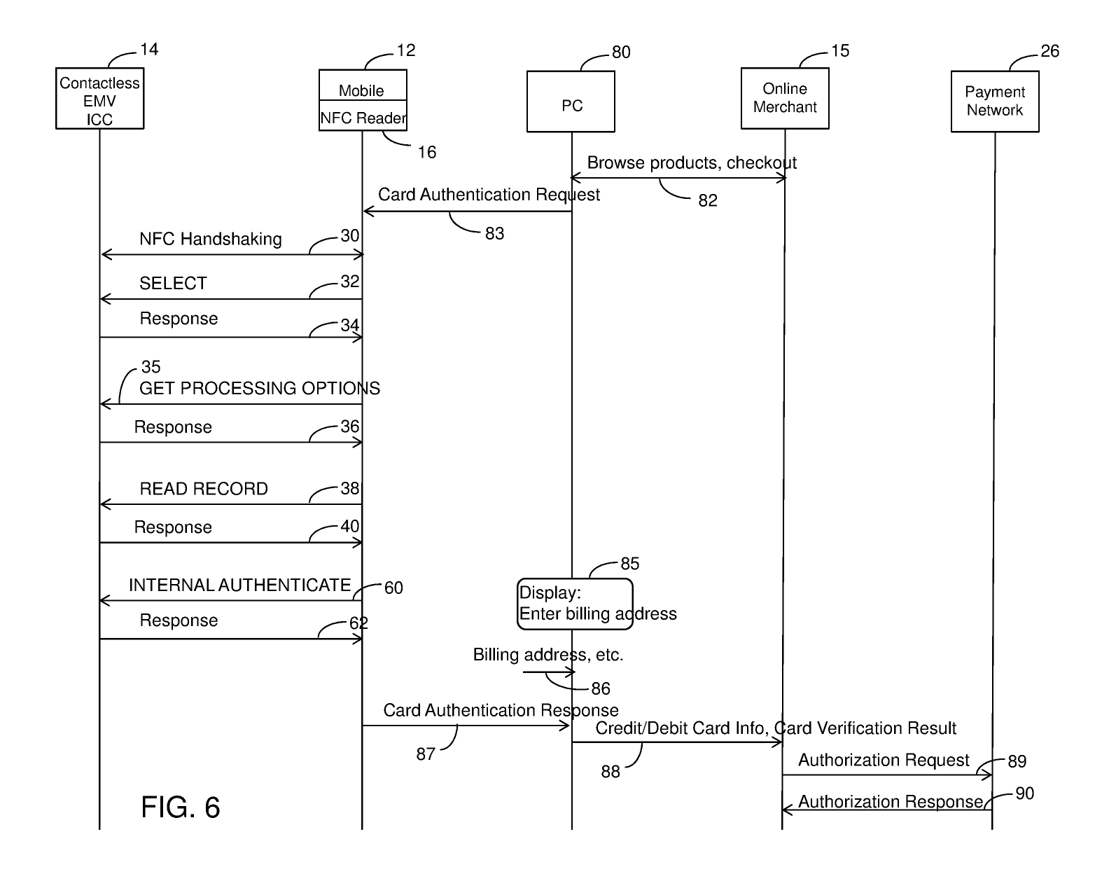

Turning now to FIG. 6, illustrated is a method in which the user may uses a desktop or laptop PC 80 to browse products and check out 82. PC 80 does not have any NFC reader, and thus, does not accept payment according to the method of the present invention. In this case, mobile device 12 with NFC reader 16 is used to read contactless EMV card 14 and forward card authentication to PC 80. PC 80 sends a Card Authentication Request message 83 to mobile device 12 with NFC reader 16. For example, PC 80 uses a cable, Bluetooth, WiFi, Ethernet or cellular network, or Internet, SMS, etc. to communicate with mobile device 12. A push notification network (not shown in the figure), e.g. Apple Push Notification Service, Google Cloud Messaging, Windows Push Notification Service, can be used to forward messages. PC 80 may need to know the mobile telephone number, IP address/UDP port number, device token, registration token, etc. in order to establish communication. A server (not shown in the figure) may be provided to forward messages between PC 80 and mobile device 12. Card Authentication Request 83 includes the card authentication option (e.g. plain card number, SDA, DDA, online verification, etc.) and/or card-holder verification that may require entering PIN code. In the following steps, DDA is assumed as an example.

Still referring to FIG. 6, in this example of the method, after card authentication request 83, the method is the same as that described with respect to FIG. 4 up until after mobile device 12 with NFC Reader 16 sends EMV INTERNAL AUTHENTICATE message 60 to EMV ICC card 14 in order to run DDA. INTERNAL AUTHENTICATE message 60 includes a random number (i.e. unpredictable number) generated by mobile device 12. EMV ICC card 14 responds with Signed Dynamic Application Data (SDAD) 62. SSAD 62 is verified by mobile device 12 using ICC Public Key for DDA. PC 80 can display 85 a request for any missing information for the user to input 86 as described previously. For example, the missing information may include billing address, phone number, and email address. Mobile device 12 sends a Card Authentication Response 87 to PC 80 to indicate the response 62. For example, it may signal DDA verified, card holder verification success, etc. Or it may include ARQC for online card authentication. Mobile device 12 sends all credit or debit card information and card verification status 88 to online merchant 15. Online merchant 15 sends authorization request 89 to payment network 26 to request transaction approval. Payment network 26 replies with authorization response 90 and the transaction is approved or rejected.

In the method illustrated in FIG. 6, mobile device 12 can connect to different online merchants 15 instead of the same merchant each time. Merchant specific information is needed to run the procedures. In the initial process before handshake 30, merchant 15 sends a message to mobile device 12 (not shown in the FIGS.), which includes merchant specific information to run merchant specific procedures in subsequent steps. This merchant specific information includes Supported Payment Brands List, etc. Supported Payment Brands List (e.g. Master, Visa, American Express, etc.) can be used by mobile device 12 to select the application or detect if the user uses the supported card by the merchant.

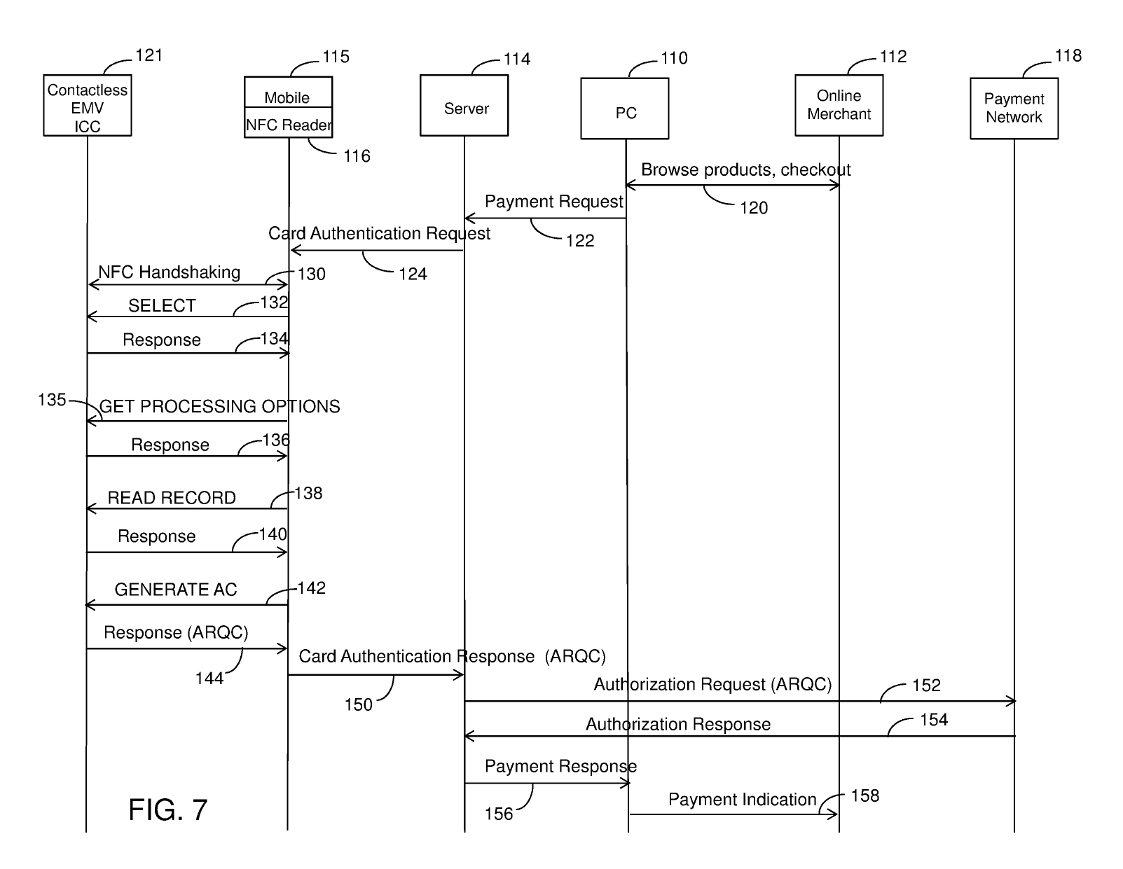

Online merchant 15 may not have the capability to process some complex, online card authentication, and therefore a 3rd party server may be used. With reference to FIG. 7, an example of a method and system in which a server is provided to directly interface with a payment network for online card authentication on behalf of an online merchant, is illustrated. The user uses PC 110 to browse an online merchant 112 and uses a server 114 to couple to a mobile device 115 with incorporated NFC reader 116. A payment network 118 received authorization requests to approve or reject transactions. The user browses and performs check out 120 from online merchant 112 and uses mobile device 115 with NFC reader 116 to authenticate a contactless EMV IC card 121. The browser of PC 110 downloads scripts to PC 110 to connect to server 114 and exchange messages. For example, PC 110 connects to server 114 via internet. PC 110 sends Payment Request message 122 to server 114. Payment Request message 122 includes transaction specific data (e.g. transaction amount, transaction currency code, transaction date), etc. Payment Request message 122 can also include a Mobile telephone number, etc. that the user inputs to identify mobile device 115 for payment. Payment Request message 122 can also include a merchant identifier. Server 114 sends Card Authentication Request message 124 to mobile device 115 with NFC reader 116. For example, server 114 can use a cellular network to communicate with mobile device 115 with SMS or cellular data. A push notification network (not shown in the figure), e.g. Apple Push Notification Service, Google Cloud Messaging, Window Push Notification Service, may be used to forward messages from server 114 to mobile device 115. Server 114 may need to know the mobile telephone number, IP address/UDP port number, device token, registration token, etc. in order to establish communication. Card Authentication Request message 124 includes transaction specific data (e.g. (e.g. transaction amount, transaction currency code, transaction date), etc.

Still referring to FIG. 7, the user positions contactless EMV IC card 121 close to mobile device 115 having NFC reader 116 capability. The mobile application detects the presence of contactless EMV IC card 121 and performs a handshaking procedure 130 as needed. Mobile device 115 with NFC reader 116 sends EMV SELECT message 132 to EMV ICC card 121 in order to determine and select the application in EMV ICC card 121 which provides the credit or debit card payment, and receives response 134. Mobile device 115 with NFC reader 116 sends EMV “GET PROCESSING OPTIONS” message 135 to EMV ICC card 121. EMV ICC card 121 responds 136 with an Application Interchange Profile and an Application File Locator (AFL), etc. An Application Interchange Profile indicates the capability of EMV ICC card 121, such as SDA (Static Data Authentication), DDA (Dynamic Data Authentication), cardholder verification to be performed, and the like. The AFL identifies the files and records containing the data to be used for the transaction. Mobile device 115 with NFC reader 116 sends EMV READ RECORD message 138 to EMV ICC card 121 in order to read data needed for the transaction. EMV ICC card 121 replies 140 with data including Application Effective/Expiration Dates, Application Primary Account Number (PAN), Cardholder Name, Track 2 Equivalent Data, and the like. Track 2 Equivalent Data contains Primary Account Number, Expiration Date, Cardholder name, etc., which may be duplicated from other parameters in the response. From response 140, mobile device 115 extracts the key information such as Primary Account Number, Cardholder Name, Expiration Date, to be provided to online merchant 112.

Mobile device 115 with NFC reader 116 sends EMV GENERATE AC message 142 to EMV ICC card 121 to request online verification. GENERATE AC message 142 includes transaction specific data (e.g. transaction amount, transaction currency code, transaction date), unpredictable number, etc. which comes from online merchant 112 during the checkout and payment stage 120. EMV ICC card 121 responds to mobile device 115 with ARQC 144 (Authorization Request Cryptogram). ARQC 144 is a cryptogram generated by EMV ICC card 121 using random number (i.e. unpredictable number), transaction specific data and ICC private key. Mobile device 115 sends Card Authentication Response message 150 to server 114. Card Authentication Response message 150 includes ARQC for online card authentication. Server 114 sends Authorization Request with ARQC 152 to payment network 118 to request transaction approval. Payment network 118 replies with Authorization Response 154 and the transaction is approved or rejected. Server 114 sends a Payment Response 156 to PC 110 to indicate the transaction approval result. PC 110 then sends a Payment Indication 158 to online merchant 112 to indicate transaction approval result.

In FIG. 7, mobile device 115 may connect to different merchants instead of the same merchant and will, therefore, need merchant specific information to run the procedures. Before handshake 130, PC 110 can send a message to server 114 with information provided by online merchant 112, to identify the merchant of this transaction, e.g. using Payment Request 122. Then server 114 can send merchant specific information, e.g. using Card Authentication Request 124, to mobile device 115 to run merchant specific procedures in subsequent steps. This merchant specific information may include Supported Payment Brands List, etc. Supported Payment Brands List (e.g. Master, Visa, American Express, etc.) can be used by mobile device 115 to select the application or detect if the user uses a card supported by the merchant.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. An online payment system comprising:
a mobile device including an NFC reader capability;
an online merchant coupled in communication between a payment network and the mobile device; and
a contactless EMV IC card containing card information for making a payment, the card information readable from the contactless EMV IC card by the NFC reader and sent to the payment network.

2. An online payment system as claimed in claim 1 wherein the mobile device includes an application facilitating interaction with the online merchant.

3. An online payment system as claimed in claim 1 further including a PC coupled in communication between the mobile device and the online store for browsing the online store and passing transaction messages between the mobile device and the online store.

4. An online payment system as claimed in claim 3 further including a server coupled in communication between the PC and the mobile device and coupled in communication with the payment network, for transferring payment messages between the PC and the mobile device and transferring payment messages between the mobile device and the payment network.

5. An online card payment method using a mobile device and contactless EMV IC card comprising the steps of:
providing a mobile device including an NFC reader capability;
coupling the mobile device in communication with an online merchant;
the mobile device receiving purchase information from the online merchant;
providing a contactless EMV IC card containing card information for making a payment;
making a payment transaction with the contactless EMV IC card by positioning the contactless EMV IC card proximate the mobile device with NFC reader capability and reading card information from the contactless EMV IC card;
authenticating the contactless EMV IC card;
transferring card information to the online merchant;
sending an authorization request from the online merchant to a payment network; and
sending an authorization response from the payment network to the online merchant, the authorization response being one of an approval and a rejection.

6. A method as claimed in claim 5 wherein the step of making a payment transaction further includes the steps of:
detecting the presence of the contactless EMV IC card and performing a handshaking procedure;
sending an EMV SELECT message from the mobile device to the contactless EMV IC card;
selecting the application in the contactless EMV IC card which provides the credit or debit card payment;
sending an EMV “GET PROCESSING OPTIONS” message from the mobile device to the contactless EMV IC card
responding with an Application Interchange Profile and an Application File Locator (AFL) from the contactless EMV IC card, to the mobile device;
sending a EMV READ RECORD message to the contactless EMV IC card; and
sending data from contactless EMV IC card needed for the transaction to the mobile device.

7. A method as claimed in claim 5 wherein the step of authenticating the contactless EMV IC card further includes the step of using at least one of offline authentication and online authentication.

8. A method as claimed in claim 7 wherein the step of offline authentication further includes using one of static data authentication (SDA) and dynamic data authentication (DDA).

9. A method as claimed in claim 8 wherein the step of authenticating the contactless EMV IC card further includes the steps of verifying Signed Static Application Data (SSAD) using an Issuer Public Key received from the EMV ICC card

10. A method as claimed in claim 8 wherein the step of authenticating the contactless EMV IC card further includes verifying Signed Dynamic Application Data (SDAD) using ICC Public Key for Dynamic Data Authentication (DDA).

11. A method as claimed in claim 7 wherein the step of online authentication further includes the steps of:
using an authorization request cryptogram (ARQC) generated by the card; and
sending the ARQC to the payment network for authentication of the card.

12. An online payment system as claimed in claim 5 wherein the step of coupling the mobile device in communication with an online merchant includes providing a PC coupled in communication between the mobile device and the online store for browsing the online store and passing transaction messages between the mobile device and the online store.

13. An online payment system as claimed in claim 12 wherein the step of coupling the mobile device in communication with an online merchant further includes providing a server coupled in communication between the PC and the mobile device and coupled in communication with the payment network, for transferring payment messages between the PC and the mobile device and transferring payment messages between the mobile device and the payment network.
